(19) United States
(12) Patent Application Publication
(10) Pub. No.: US 2025/0246597 A1
(43) Pub. Date: Jul. 31, 2025

(54) THIN-FILM POSITIVE ELECTRODE FOR THERMAL BATTERY, THERMAL BATTERY INCLUDING THE SAME, AND MANUFACTURING METHOD THEREOF

(71) Applicant: AGENCY FOR DEFENSE DEVELOPMENT, Daejeon (KR)

(72) Inventors: Won Jun AHN, Daejeon (KR); Mi Seon PARK, Daejeon (KR); Jae In LEE, Daejeon (KR); Tae Young AHN, Daejeon (KR); Sang Hyeon HA, Daejeon (KR); Yusong CHOI, Daejeon (KR)

(73) Assignee: AGENCY FOR DEFENSE DEVELOPMENT, Daejeon (KR)

(21) Appl. No.: 19/026,553

(22) Filed: Jan. 17, 2025

(30) Foreign Application Priority Data
Jan. 30, 2024 (KR) 10-2024-0014339

(51) Int. Cl. H01M 4/12; H01M 4/02; H01M 4/04; H01M 4/52; H01M 4/58; H01M 4/62; H01M 4/66; H01M 6/36

(52) U.S. Cl. CPC H01M 4/12; H01M 4/0404; H01M 4/0435; H01M 4/0471; H01M 4/52; H01M 4/5815; H01M 4/62; H01M 4/663; H01M 6/36; H01M 2004/021

(57) ABSTRACT

A method of manufacturing a thermal battery includes performing physical surface treatment so that a current collector has a rough surface, preparing a positive electrode slurry by mixing a positive electrode active material, a eutectic salt (or a single salt), a binder, and a solvent, applying the positive electrode slurry to the current collector, and preparing a thin-film positive electrode by drying and rolling the current collector to which the positive electrode slurry is applied.

### CROSS-REFERENCE TO RELATED APPLICATION

This application is based on and claims priority under 35 U.S.C. § 119 to Korean Patent Application No. 10-2024-0014339, filed on Jan. 30, 2024, in the Korean Intellectual Property Office, the disclosure of which is incorporated by reference herein in its entirety.

### BACKGROUND OF THE INVENTION

### 1. Technical Field

The disclosure relates to a thermal battery with high capacity, high power, and high stability, and a method of manufacturing a thermal battery which may increase productivity and reduce process costs.

### 2. Description of Related Art

A thermal battery is a reserve primary battery that is inactive at room temperature and is activated within a few seconds by melting a solid electrolyte by ignition of a heat source.

In particular, in the case of military weapons including propellants such as torpedoes and rockets, because the average lifespan is 15 years or more and power is used only at the moment of launch, self-discharging should not occur. In addition, it is preferable that power sources of military weapons such as aircraft and propellants are lightweight. Because an electrolyte is in a solid state when a thermal battery is deactivated, self-discharging may be prevented. Because a thermal battery may withstand vibration, impact, low temperature, and high temperature and thus has excellent structural stability and reliability, thermal batteries may be used as power sources for military weapons.

To manufacture an electrode included in a thermal battery, a method of pressing powder by using a hydraulic press and forming the powder into a pellet shape is mainly used. This method has the advantage of minimizing the use of a binder.

However, this manufacturing method has a problem in that it is difficult to achieve high power and weight reduction of the thermal battery because a thickness of the electrode should be increased in order to improve the power characteristics of the thermal battery.

In order to solve this problem, many studies have been conducted to apply a thin-film electrode to a thermal battery. When a thin-film electrode is used, a thin electrode with improved power characteristics may be manufactured.

In particular, among methods of manufacturing thin-film electrodes, a tape casting process has the advantage of excellent uniformity and mass production, and thus, is used in various ways for electrodes of capacitors and lithium secondary batteries.

However, a conventional tape casting process has a problem in that it is difficult to increase the loading amount of an active material loaded onto a current collector. In particular, the above problem becomes more serious when the tape casting process is applied to an electrode used in a thermal battery.

Thermal batteries that may be used for military weapons or the like are required to have very high capacity and are assumed to operate at high temperatures. In the case of electrodes used in general secondary batteries or capacitors, the capacity problem may be solved to some extent by increasing the content of a polymer binder in a slurry. However, because thermal batteries operate at high temperatures, the use or content of a polymer binder is limited. Accordingly, it is very difficult to increase the loading amount of an active material.

Also, when the loading amount of the electrode is increased by using a small amount of binder, problems such as peeling of an active material or cracking of the electrode may occur.

### SUMMARY OF THE INVENTION

Provided are a thermal battery with high capacity, high power, and high stability, and a method of manufacturing a thermal battery which may increase productivity and reduce process costs.

Technical objectives to be achieved by the disclosure are not limited thereto, and other unmentioned technical objectives will be apparent to one of ordinary skill in the art to which the disclosure pertains from the following description.

Additional aspects will be set forth in part in the description which follows and, in part, will be apparent from the description, or may be learned by practice of the presented embodiments. According to an aspect of the disclosure, a method of manufacturing a thermal battery

includes performing physical surface treatment so that a current collector has a rough surface, preparing a positive electrode slurry by mixing a positive electrode active material, a eutectic salt (or a single salt), a binder, and a solvent, applying the positive electrode slurry to the current collector, and preparing a thin-film positive electrode by drying and rolling the current collector to which the positive electrode slurry is applied.

The method may further include manufacturing a unit cell by stacking the thin-film positive electrode, an electrolyte, and a negative electrode.

The current collector may be a carbon-based current collector including a crystalline carbon material.

The physical surface treatment may be a method of attaching a tape to a surface of the current collector and then removing the tape to increase a specific surface area of the current collector.

The positive electrode active material may include at least one of FeS₂, NiS₂, and CoS₂.

The eutectic salt may include at least one of LiCl, KCl, LiBr, and KBr, and the single salt is LiCl, KCl, LiBr, or KBr.

The solvent may be an aqueous solvent.

The aqueous solvent may include water and alcohol, and a weight ratio of the alcohol to the water may be about 0.2 to about 0.6.

The alcohol may have 1 to 4 carbon atoms.

The binder may include fumed silica, and the fumed silica may be included in an amount of about 0.2 wt % to about 2 wt % based on a total weight of the positive electrode slurry excluding the solvent.

The applying of the positive electrode slurry to the current collector may include applying the positive electrode slurry to the current collector by using a tape casting method using a doctor blade.

In the preparing of the thin-film positive electrode by drying and rolling the current collector to which the positive electrode slurry is applied, a loading amount of the positive electrode slurry may be about 300 μm to about 1,500 μm.

In the preparing of the thin-film positive electrode by drying and rolling the current collector to which the positive electrode slurry is applied, a rolling rate may be about 5% to about 50%.

The preparing of the thin-film positive electrode by drying and rolling the current collector to which the positive electrode slurry is applied may include performing drying in a vacuum oven at a temperature of about 60° C. to about 150° C.

According to an aspect of the disclosure, a thin-film positive electrode for a thermal battery includes a carbon-based current collector, and a positive electrode active material layer disposed on the carbon-based current collector, wherein a thickness of the positive electrode active material layer is about 300 μm to about 1500 μm.

The positive electrode active material layer may include at least one of FeS₂, NiS₂, and CoS₂.

The carbon-based current collector may include at least one of a graphite sheet, a carbon sheet, graphite foil, carbon paper, glassy carbon, and a graphite film.

According to an aspect of the disclosure, a thermal battery includes a negative electrode and a positive electrode, and an electrolyte disposed between the negative electrode and the positive electrode, wherein the positive electrode includes a carbon-based current collector and a positive electrode active material layer disposed on the carbon-based current collector, wherein a thickness of the positive electrode active material layer is about 300 μm to about 1500 μm.

The positive electrode active material layer may include at least one of FeS₂, NiS₂, and CoS₂.

The carbon-based current collector may include at least one of a graphite sheet, a carbon sheet, graphite foil, carbon paper, glassy carbon, and a graphite film.

Other aspects, features, and advantages of the disclosure will become more apparent from the drawings, the claims, and the detailed description.

### BRIEF DESCRIPTION OF THE DRAWINGS

The above and other aspects, features, and advantages of certain embodiments will be more apparent from the following description taken in conjunction with the accompanying drawings, in which:

FIG. 1 is a flowchart illustrating a method of manufacturing a thermal battery, according to an embodiment;

FIG. 2 is a cross-sectional view schematically illustrating a thermal battery, according to an embodiment;

FIG. 3 is an exploded view illustrating a thermal battery, according to an embodiment;

FIG. 4 is a view illustrating a thin-film positive electrode before being cut, according to an embodiment;

FIG. 5 is a view illustrating a cut thin-film positive electrode, according to an embodiment;

FIG. 6 is a view illustrating a thin-film positive electrode, according to an embodiment;

FIG. 7 is a view illustrating a cut thin-film positive electrode, according to a comparative example;

FIG. 8 is a view illustrating a thin-film positive electrode before being cut, according to a comparative example;

FIG. 9 is a view illustrating a thin-film positive electrode before being cut, according to a comparative example; and

FIG. 10 is a graph illustrating discharge test results according to a comparative example and an embodiment.

### DETAILED DESCRIPTION OF THE EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

As the disclosure allows for various changes and numerous embodiments, certain embodiments will be illustrated in the drawings and described in the detailed description. Effects and features of the disclosure, and methods for achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings, wherein the same or corresponding elements may be denoted by the same reference numerals throughout and a repeated description thereof may be omitted.

While such terms as “first,” “second,” etc., may be used to describe various components, such components are not be limited to the above terms. The above terms are used only to distinguish one component from another.

The singular forms “a,” “an,” and “the” as used herein are intended to include the plural forms as well unless the context clearly indicates differently.

It will be understood that the terms “including” and “having” are intended to indicate the existence of the features or elements described in the specification, and are not intended to preclude the possibility that one or more other features or elements may exist or may be added.

It will be further understood that, when a layer, region, or component is referred to as being “on” another layer, region, or component, it may be directly on the other layer, region, or component, or may be indirectly on the other layer, region, or component with intervening layers, regions, or components therebetween.

In the specification, it will be understood that when a layer, a region, or a component is referred to as being “connected” to another layer, region, or component, it may be “directly connected” to the other layer, region, or component and/or may be “indirectly connected” to the other layer, region, or component with other layers, regions, or components interposed therebetween. For example, when a layer, a region, or a component is referred to as being “electrically connected,” it may be directly electrically connected, and/or may be indirectly electrically connected with intervening layers, regions, or components therebetween.

“A and/or B” is used herein to select only A, select only B, or select both A and B. “At least one of A and B” is used to select only A, select only B, or select both A and B.

In the following embodiments, the x-axis, the y-axis and the z-axis are not limited to three axes of the rectangular coordinate system, and may be interpreted in a broader sense. For example, the x-axis, the y-axis, and the z-axis may be perpendicular to one another or may represent different directions that are not perpendicular to one another.

The term “substantially,” “about,” and similar terms are used as terms of approximation and not as terms of degree, and are intended to account for the inherent variations in measured or calculated values that would be recognized by one of ordinary skill in the art. For example, “about” may be construed to include values in a range of +30%, +20%, +10%, or +5% of a numerical value.

The expression “an element B is directly disposed on an element A” may mean that an additional adhesive layer or adhesive member is not arranged between the element A and the element B. In this case, the element B may be formed through a continuous process on a base surface provided by the element A, after the element A is formed.

As used herein, the expression “A and B overlap each other” may indicate that when a plane (e.g., an x-y plane) perpendicular to one direction (e.g., a z-axis direction) is viewed from the one direction, at least a portion of A and at least a portion B are arranged to overlap each other on the plane.

When a certain embodiment may be implemented differently, a specific process order may be different from the described order. For example, two consecutively described processes may be performed substantially at the same time or may be performed in an order opposite to the described order.

Sizes of components in the drawings may be exaggerated or reduced for convenience of explanation. For example, because sizes and thicknesses of components in the drawings are arbitrarily illustrated for convenience of explanation, the disclosure is not limited thereto.

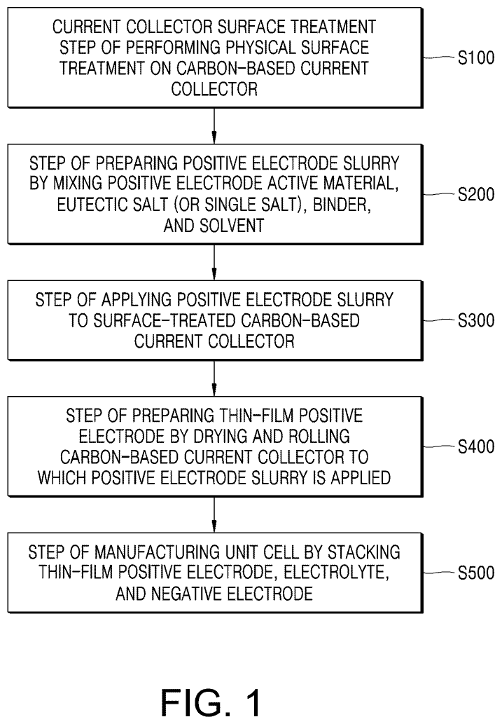

FIG. 1 is a flowchart illustrating a method of manufacturing a thermal battery, according to an embodiment.

Referring to FIG. 1, a method of manufacturing a thermal battery according to an embodiment may include a current collector surface treatment step S100 of performing physical surface treatment so that a current collector has a rough surface, a step S200 of preparing a positive electrode slurry by mixing a positive electrode active material, a eutectic salt (or a single salt), a binder, and a solvent, a step S300 of applying the positive electrode slurry to the surface-treated current collector, a step S400 of preparing a thin-film positive electrode by drying and rolling the current collector to which the positive electrode slurry is applied, and a step S500 of manufacturing a unit cell by stacking the thin-film positive electrode, an electrolyte, and a negative electrode.

In the current collector surface treatment step S100 of performing physical surface treatment so that the current collector has a rough surface, the current collector may have a rough surface by performing physical treatment on a surface of the current collector to minimize peeling of the positive electrode active material and the current collector.

In an embodiment, the current collector may be a carbon-based current collector. That is, the current collector may include a crystalline carbon material. For example, the current collector may include at least one of a graphite sheet, a carbon sheet, graphite foil, carbon paper, glassy carbon, and a graphite film.

Physical surface treatment may be performed as a method for increasing a specific surface area of the carbon-based current collector. For example, the physical surface treatment may include scratches, punctures, or peeling causing fluff. In an embodiment, for the physical surface treatment, a rough surface may be exposed by rubbing the surface of the carbon-based current collector with an awl or sandpaper, or attaching a tape to the surface of the carbon-based current collector and then removing the tape.

The carbon-based current collector on which the physical surface treatment has been performed may have an increased specific surface area in contact with the positive electrode slurry, thereby improving a contact force with the slurry. That is, peeling of the current collector and the active material may be suppressed.

In the step S200 of preparing the positive electrode slurry by mixing the positive electrode active material, the eutectic salt (or the single salt), the binder, and the solvent, the positive electrode slurry to be applied to the current collector may be prepared.

The step S200 of preparing the positive electrode slurry by mixing the positive electrode active material, the eutectic salt (or the single salt), the binder, and the solvent may be performed before, after, or simultaneously with the current collector surface treatment step S100 of performing physical surface treatment so that the current collector has a rough surface.

A general positive electrode active material for a thermal battery may be used as the positive electrode active material. In an embodiment, the positive electrode active material may include at least one of FeS₂, NiS₂, and CoS₂.

The eutectic salt (or the single salt) may include at least one of LiCl, KCl, LiBr, and KBr. When the single salt is used, the single salt may be LiCl, KCl, LiBr, or KBr. When the eutectic salt is used, the eutectic salt may be a composition including at least one of LiCl, KCl, LiBr, and KBr. For example, the eutectic salt may be a LiCl—KCl eutectic salt, a LiF—LiCl—LiBr eutectic salt, a LiBr—KBr—RbCl eutectic salt, or a LiCl—LiBr—RbCl eutectic salt.

The binder may include MgO and/or fumed silica. The fumed silica may adjust the viscosity of the positive electrode slurry.

The fumed silica may be included in an amount of about 2 wt % or less based on a total weight of the positive electrode slurry excluding the solvent. In an embodiment, the fumed silica may be included in an amount of about 1 wt % or less based on the total weight of the positive electrode slurry excluding the solvent. The fumed silica may reduce the viscosity of the slurry, thereby reducing the amount of solvent used and preventing cracks during the preparation of the positive electrode. However, when the fumed silica is excessively added, an adhesive force of the positive electrode slurry to the current collector may be excessively reduced.

The fumed silica may be included in an amount of about 0.2 wt % or more based on the total weight of the positive electrode slurry excluding the solvent. When the content of fumed silica is too low, the effect of reducing the viscosity of the slurry may not be sufficient.

The solvent used to prepare the positive electrode slurry may be an aqueous solvent. The solvent may be used as a single substance or a mixture of one or more substances. In an embodiment, the aqueous solvent may include water and alcohol having 1 to 4 carbon atoms. For example, the aqueous solvent may include water, and ethanol, propanol, or isopropyl alcohol.

The alcohol included in the solvent may reduce the viscosity of the positive electrode slurry, which may be advantageous in a process. When the thin-film positive electrode is prepared through a tape casting process, an excessive amount of water may be used to reduce the viscosity of the slurry. In this case, because the water condenses and vaporizes when the slurry is dried, cracks may occur on a surface of the positive electrode. Accordingly, when the alcohol and the water are mixed and used, less water may be used, thereby minimizing the occurrence of cracks. Also, because vaporization temperatures of substances included in the solvent are different, the positive electrode may be slowly dried stepwise in the positive electrode drying step, thereby reducing cracks on the surface of the positive electrode.

However, when the content of alcohol included in the solvent is too high, the solvent may vaporize rapidly, which may cause cracks on the surface during the preparation of the positive electrode.

Accordingly, a weight ratio of the alcohol to the water included in the solvent (alcohol [wt %]/water [wt %]) may be about 1 or less. Preferably, the weight ratio of the alcohol to the water included in the solvent may be about 0.2 to about 0.6.

After the current collector surface treatment step S100 of performing physical surface treatment so that the current collector has a rough surface and the step S200 of preparing the positive electrode slurry by mixing the positive electrode active material, the eutectic salt (or single salt), the binder, and the solvent, the step S300 of applying the positive electrode slurry to the surface-treated current collector may be performed.

When the positive electrode slurry to the surface-treated current collector, a method such as spin coating, slot-die coating, roll coating, or tape casting may be used. In an embodiment, a tape casting method using a doctor blade may be used to apply the positive electrode slurry to the current collector.

The loading amount of the positive electrode slurry may be about 300 μm to about 1,500 μm. Preferably, the loading amount of the positive electrode slurry may be about 400 μm to about 1,000 μm.

The term “loading amount” used herein may refer to a thickness after the positive electrode slurry applied to the current collector is dried (as described below).

After the step S300 of applying the positive electrode slurry to the surface treated current collector, the step S400 of preparing the thin-film positive electrode by drying and rolling the current collector to which the positive electrode slurry is applied may be performed. The current collector to which the positive electrode slurry is applied may be dried at

room temperature until a surface is dried. Next, the solvent may be completely dried in a vacuum oven at a temperature of about 60° C. to about 150° C. When a drying temperature is too low, it may take too long to dry the solvent, which may increase process costs. When a drying temperature is too high, a drying speed may be too fast, which may cause cracks on the surface.

In the dried positive electrode, the dried positive electrode slurry, that is, a positive electrode active material layer, is formed on the current collector.

The dried positive electrode may be pressed and rolled. When the electrode is rolled, cracks on the surface of the electrode may be reduced and a thickness may become uniform, and thus, an adhesive force between the positive electrode active material layer and the current collector may increase and peeling of the positive electrode active material layer from the current collector may be minimized. Also, the density of the positive electrode active material layer may increase, thereby increasing the capacity per volume of the positive electrode.

When a rolling rate is too low, the effect of rolling may be insignificant.

Accordingly, a rolling rate may be about 5% or more. Preferably, a rolling rate may be about 10% or more.

However, excessive rolling may cause cracks in the positive electrode. Accordingly, a rolling rate may be about 50% or less. Preferably, a rolling rate may be about 30% or less.

The term “rolling rate” used herein may refer to a degree to which the dried positive electrode slurry is rolled, excluding a thickness of the current collector.

The thin-film positive electrode may be prepared by drying the current collector to which the positive electrode slurry is applied and rolling the dried positive electrode.

After the step S400 of preparing the thin-film positive electrode by drying and rolling the current collector to which the positive electrode slurry is applied, the step S500 of manufacturing the unit cell by stacking the thin-film positive electrode, the electrolyte, and the negative electrode may be performed.

The thermal battery may have a form in which one or more unit cells are stacked to increase an operating voltage. The unit cell may be manufactured by stacking the thin-film positive electrode, the electrolyte, and the negative electrode.

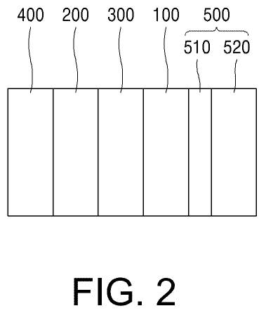

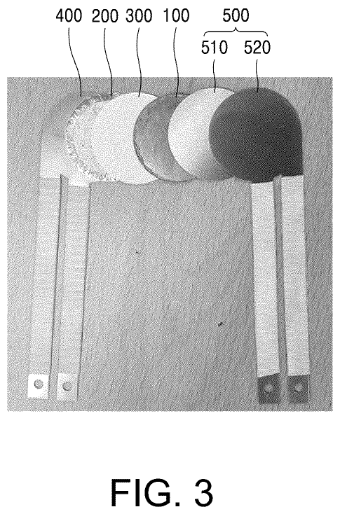

FIG. 2 is a cross-sectional view schematically illustrating a thermal battery, according to an embodiment. FIG. 3 is an exploded view illustrating a thermal battery, according to an embodiment.

In detail, FIG. 2 is a cross-sectional view schematically illustrating a thermal battery including one unit cell. FIG. 3 is an exploded perspective view illustrating a thermal battery including one unit cell.

A thermal battery according to an embodiment may include a thin-film positive electrode 100, a negative electrode 200, an electrolyte, 300, a negative electrode current collector 400, and a positive electrode current collector 500.

The electrolyte 300 may be disposed between the thin-film positive electrode 100 and the negative electrode 200. That is, the thin-film positive electrode 100, the electrolyte 300, and the negative electrode 200 may be sequentially stacked.

The electrolyte 300 usually electrically and physically separates the thin-film positive electrode 100 from the negative electrode 200, and when heat is applied, the electrolyte 300 may melt and function as an electrolyte.

The negative electrode current collector 400 may be disposed on a surface of the negative electrode 200 not adjacent to the electrolyte 300, and the positive electrode current collector 500 may be disposed on a surface of the thin-film positive electrode 100 not adjacent to the electrolyte 300.

In an embodiment, the negative electrode current collector 400 may include copper or a copper alloy. The negative electrode current collector 400 may be a lead terminal including a terminal for applying current of the battery and a sensor for measuring a voltage.

The positive electrode current collector 500 may include a first positive electrode current collector 510 and a second positive electrode current collector 520. The first positive electrode current collector 510 may be disposed adjacent to the thin-film positive electrode 100, and the second positive electrode current collector 520 may be disposed on a surface of the first positive electrode current collector 510 not adjacent to the thin-film positive electrode 100. That is, the first positive electrode current collector 510 may be disposed between the second positive electrode current collector 520 and the thin-film positive electrode 100.

The second positive electrode current collector 520 may be a lead terminal including a terminal for applying current of the battery and a sensor for measuring a voltage.

The second positive electrode current collector 520 may include copper or a copper alloy, and the first positive electrode current collector 510 may include nickel or stainless steel. Because the thin-film positive electrode 100 prepared by applying a positive electrode

slurry to a current collector is used in the disclosure, the first positive electrode current collector 510 may be omitted.

A thermal battery according to an embodiment may include at least one unit cell. When the thermal battery includes a plurality of unit cells, the unit cells may be connected in series, and as the number of connected unit cells increases, an output voltage of the thermal battery may increase.

Because the thermal battery according to an embodiment includes a thin-film positive electrode as described above, the thermal battery may have high capacity and high power, may minimize cracks of a positive electrode, and may have high stability. Also, a method of manufacturing a thermal battery according to an embodiment may have high productivity and may reduce process costs through a continuous process of tape casting.

### EXPERIMENTAL EXAMPLES

Hereinafter, the disclosure will be described through experimental examples. However, the following experimental examples are intended to explain the disclosure in more detail, and the scope of the disclosure is not limited by the following experimental examples. The following experimental examples may be appropriately modified and changed by one of ordinary skill in the art within the scope of the disclosure.

### Thin-Film Positive Electrode Preparation Experiments

### Embodiment 1-1

Physical surface treatment was performed by attaching a tape to a carbon-based current collector (graphite sheet) having a thickness of 250 μm and removing the tape several times.

A positive electrode slurry was prepared by mixing 12 g of FeS₂ positive electrode active material, a eutectic salt including 1.2 g of LiCl and 1.2 g of KCl, and a binder including 1 g of MgO and 0.5 g of fumed silica with a solvent including 5 g of water and 1 g of ethanol.

The positive electrode slurry was applied the surface-treated carbon-based current collector by using a doctor blade.

A resultant structure was dried in a vacuum oven at 100° C. for 6 hours, and rolling was performed at a rolling rate of 20% by using a roll press. In this case, a thickness of the positive electrode slurry after the rolling (positive electrode active material layer) was 560 μm.

A thin-film positive electrode to be used for a thermal battery was prepared by cutting the dried and rolled positive electrode by using a circular cutting tool having a diameter of 12 mm.

### Comparative Example 1

A thin-film positive electrode was prepared in the same manner as in Embodiment 1 except that a carbon-based current collector without surface treatment was used.

### Comparative Example 2

A thin-film positive electrode was prepared in the same manner as in Embodiment 1 except that the content of fumed silica was increased to 2 g.

### Comparative Example 3

A thin-film positive electrode was prepared in the same manner as in Embodiment 1 except that a weight ratio of alcohol to water included in a solvent was increased to 1.5.

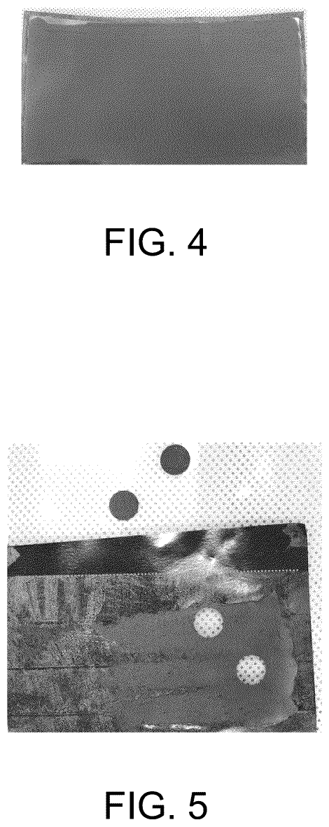

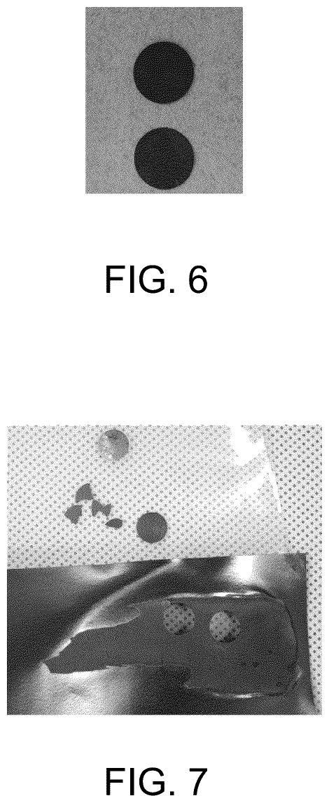

FIG. 4 is a view illustrating a thin-film positive electrode before being cut, according to an embodiment. FIG. 5 is a view illustrating a cut thin-film positive electrode, according to an embodiment. FIG. 6 is a view illustrating a thin-film positive electrode, according to an embodiment. In detail, FIGS. 4 to 6 are views illustrating a thin-film positive electrode before and after cutting according to Embodiment 1-1.

FIG. 7 is a view illustrating a cut thin-film positive electrode, according to a comparative example. In detail, FIG. 7 is a view illustrating a cut thin-film positive electrode according to Comparative Example 1.

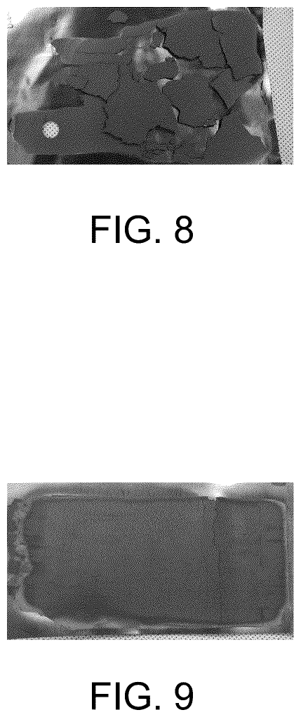

FIG. 8 is a view illustrating a thin-film positive electrode before being cut, according to a comparative example. In detail, FIG. 8 is a view illustrating a thin-film positive electrode before being cut according to Comparative Example 2.

FIG. 9 is a view illustrating a thin-film positive electrode before being cut, according to a comparative example. In detail, FIG. 9 is a view illustrating a thin-film positive electrode before being cut according to Comparative Example.

Referring to FIGS. 4 to 6, it is observed that in the thin-film positive electrode according to Embodiment 1, cracks did not occur on a surface even after the positive electrode slurry was dried and rolled on the current collector, and the positive electrode active material layer may be maintained in a circular shape without peeling from the current collector even after cutting because an adhesive force between the positive electrode active material layer and the current collector was excellent due to the surface treatment of the current collector.

However, referring to FIGS. 7 to 9, it is observed that in the thin-film positive electrode according to Comparative Example 1, the positive electrode active material layer peeled from the current collector after cutting; in the thin-film positive electrode according to Comparative Example 2, excessive cracks occurred even before cutting; and in the thin-film positive electrode according to Comparative Example 3, cracks occurred on the surface.

### Thin-Film Positive Electrode Preparation Experiments According to Solvent and Thickness of Slurry

A positive electrode slurry was applied to a current collector by a thickness of a slurry shown in Table 1 and Table 2, and other process conditions were the same as those in Embodiment 1-1. However, in an experimental example using a solvent including only water, ethanol in Embodiment 1-1 was replaced with the same amount of water. Also, Table 1 shows an experimental example in which physical surface treatment was performed on a carbon-based current collector as in Embodiment 1-1, and Table 2 shows an experimental example in which physical surface treatment was not performed on a carbon-based current collector.

TABLE 1

Solvent

| Slurry thickness | | Mixture of water |
|---|---|---|
| (μm) | Only water is used | and ethanol is used |
| 500 | ◯ | ◯ |
| 700 | Δ | ◯ |
| 900 | Δ | ◯ |
| 1100 | X | Δ |
| 1300 | X | Δ |
| 1500 | X | Δ |

TABLE 2

Solvent

| Slurry thickness | | Mixture of water |
|---|---|---|
| (μm) | Only water is used | and ethanol is used |
| 500 | Δ | ◯ |
| 700 | Δ | ◯ |
| 900 | X | Δ |
| 1100 | X | Δ |
| 1300 | X | X |
| 1500 | X | X |

### <Electrode State Criteria>

∘: No abnormality in the electrode
Δ: Some cracks are observed on the electrode surface, but the electrode may be used.
X: Cracks and peeling occur on the electrode surface, and thus, the electrode may not be used.

Referring to Table 1 and Table 2, the loading amount of the positive electrode slurry was increased when the solvent including a mixture of water and ethanol was used. Also, the loading amount of the slurry was increased to the maximum when the surface treatment was performed on the current collector and the solvent including a mixture of water and ethanol was used.

### Thermal Battery Discharge Test

### Embodiment 2-1

Preparation was performed in the same manner as in Embodiment 1-1. However, a thin-film positive electrode to be used for a thermal battery was prepared by cutting a positive electrode by using a circular cutting tool having a thickness of 29 mm.

Next, a unit cell was manufactured by stacking a negative electrode, an electrolyte, the thin-film positive electrode, and a current collector.

### Comparative Example 4

A pellet-type positive electrode was prepared by using a pressing method, instead of a tape casting process. A pellet-type electrode having a diameter of 29 mm was prepared in the same manner as in Embodiment 2-1, 0.6 g of active material, 0.26 g of eutectic salt, and 0.04 g of binder were used, and fumed silica was not used.

Next, a unit cell was manufactured by stacking a negative electrode, an electrolyte, the positive electrode, and a current collector.

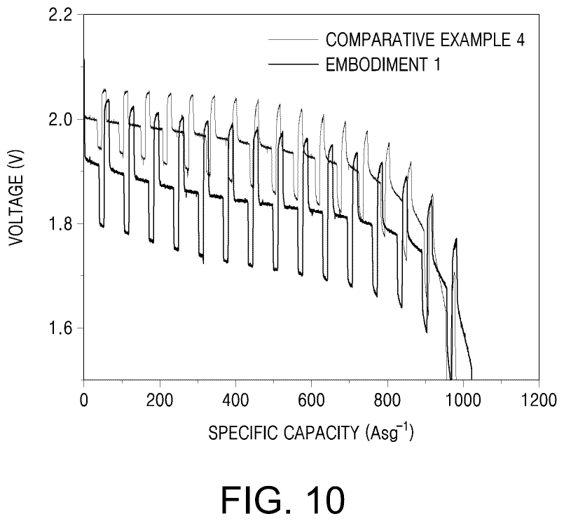

FIG. 10 is a graph illustrating discharge test results according to a comparative example and an embodiment.

A discharge test was repeatedly performed in the order of applying current of 5 A for 3 seconds after pressing at 100 Kgf in a press of 500° C., applying current of 10 A for 1 second, and resting for 1 second until a voltage of a battery reached 0.

Referring to FIG. 10, Comparative Example 4 shows a slightly higher voltage in most sections than Embodiment 2-1. It is analyzed that this is because Embodiment 2-1 included a carbon-cased current collector not included in Comparative Example 4, and thus had higher resistance.

When capacity is calculated based on the content of FeS₂, which is a positive electrode active material, Comparative Example 4 shows a specific capacity of about 980 Asg⁻¹ and Embodiment 2-1 shows a specific capacity of about 1020 Asg⁻¹, and thus Embodiment 2-1 shows better performance than Comparative Example 4.

According to an embodiment as described above, a thermal battery with high capacity, high power, and high stability and a method of manufacturing a thermal battery which may increase productivity and reduce process costs may be provided.

The scope of the disclosure is not limited by the above-mentioned effects, and other effects not mentioned will be clearly understood by one of ordinary skill in the art to which the disclosure pertains from the specification and the attached drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by one of ordinary skill in the art that various changes in form and details may be made therein without departing from the spirit and scope of the disclosure as defined by the following claims.

What is claimed is:

1. A method of manufacturing a thermal battery, the method comprising:
performing physical surface treatment so that a current collector has a rough surface;
preparing a positive electrode slurry by mixing a positive electrode active material, a eutectic salt (or a single salt), a binder, and a solvent;
applying the positive electrode slurry to the current collector; and
preparing a thin-film positive electrode by drying and rolling the current collector to which the positive electrode slurry is applied.

2. The method of claim 1, further comprising manufacturing a unit cell by stacking the thin-film positive electrode, an electrolyte, and a negative electrode.

3. The method of claim 1, wherein the current collector is a carbon-based current collector comprising a crystalline carbon material.

4. The method of claim 1, wherein the physical surface treatment is a method of attaching a tape to a surface of the current collector and then removing the tape to increase a specific surface area of the current collector.

5. The method of claim 1, wherein the positive electrode active material comprises at least one of FeS₂, NiS₂, and CoS₂.

6. The method of claim 1, wherein the eutectic salt comprises at least one of LiCl, KCl, LiBr, and KBr, and the single salt is LiCl, KCl, LiBr, or KBr.

7. The method of claim 1, wherein the solvent is an aqueous solvent.

8. The method of claim 7, wherein the aqueous solvent comprises water and alcohol, and a weight ratio of the alcohol to the water is 0.2 to 0.6.

9. The method of claim 8, wherein the alcohol has 1 to 4 carbon atoms.

10. The method of claim 1, wherein the binder comprises fumed silica, and the fumed silica is included in an amount of about 0.2 wt % to about 2 wt % based on a total weight of the positive electrode slurry excluding the solvent.

11. The method of claim 1, wherein the applying of the positive electrode slurry to the current collector comprises applying the positive electrode slurry to the current collector by using a tape casting method using a doctor blade.

12. The method of claim 1, wherein, in the preparing of the thin-film positive electrode by drying and rolling the current collector to which the positive electrode slurry is applied, a loading amount of the positive electrode slurry is about 300 μm to about 1,500 μm.

13. The method of claim 1, wherein, in the preparing of the thin-film positive electrode by drying and rolling the current collector to which the positive electrode slurry is applied, a rolling rate is about 5% to about 50%.

14. The method of claim 1, wherein the preparing of the thin-film positive electrode by drying and rolling the current collector to which the positive electrode slurry is applied comprises performing drying in a vacuum oven at a temperature of about 60° C. to about 150° C.

15. A thin-film positive electrode for a thermal battery, the thin-film positive electrode comprising:
a carbon-based current collector; and
a positive electrode active material layer disposed on the carbon-based current collector,
wherein a thickness of the positive electrode active material layer is about 300 μm to about 1500 μm.

16. The thin-film positive electrode of claim 15, wherein the positive electrode active material layer comprises at least one of FeS₂, NiS₂, and CoS₂.

17. The thin-film positive electrode of claim 15, wherein the carbon-based current collector comprises at least one of a graphite sheet, a carbon sheet, graphite foil, carbon paper, glassy carbon, and a graphite film.

18. A thermal battery comprising:
a negative electrode and a positive electrode; and
an electrolyte disposed between the negative electrode and the positive electrode,
wherein the positive electrode comprises a carbon-based current collector and a positive electrode active material layer disposed on the carbon-based current collector,
wherein a thickness of the positive electrode active material layer is about 300 μm to about 1500 μm.

19. The thermal battery of claim 18, wherein the positive electrode active material layer comprises at least one of FeS₂, NiS₂, and CoS₂.

20. The thermal battery of claim 18, wherein the carbon-based current collector comprises at least one of a graphite sheet, a carbon sheet, graphite foil, carbon paper, glassy carbon, and a graphite film.
